(19) United States
(12) Patent Application Publication
(10) Pub. No.: US 2010/0113654 A1
(43) Pub. Date: May 6, 2010

(54) FLAME-RESISTANT RESIN COMPOSITION

(75) Inventors: Yoshinobu SUGATA, Miiura-shi (JP); Toshiyuki KANNO, Kawasaki- shi (JP)

Correspondence Address: ROSSI, KIMMS & McDOWELL LLP., 20609 Gordon Park Square, Suite 150, Ashburn, VA, 20147, US

(73) Assignee: FUJI ELECTRIC FA COMPONENTS & SYSTEMS CO., LTD., Tokyo (JP)

(21) Appl. No.: 12/553,293

(22) Filed: Sep. 3, 2009

(30) Foreign Application Priority Data
Sep. 29, 2008 (JP) 2008-249710

(51) Int. Cl. C08K 5/5313; C08K 5/3492

(52) U.S. Cl. 524/101

(57) ABSTRACT

A flame-resistant resin composition is disclosed that uses a non-halogen flame retardant as the flame retardant, and allows resin processed articles to be obtained which have superior flame resistance and heat resistance. The flame-resistant resin composition comprises a non-halogen flame retardant (A) containing a metal phosphinate (a) represented by the following formula (I)

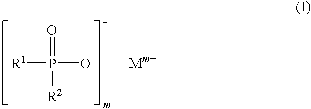

wherein, R1 and R2 respectively represent an alkyl group having 1 to 6 carbon atoms or an aryl group having 12 carbon atoms or less, M represents calcium, aluminum or zinc, m=3 when M is aluminum, and m=2 when M is other than aluminum, and an organic phosphorous flame retardant (b), an isocyanurate compound (B) having one or more glycidyl groups in the molecular structure thereof, and a thermoplastic resin (C).

### BACKGROUND OF THE INVENTION

A. Field of the Invention

The present invention relates to a flame-resistant resin composition used in, for example, electrical components and electronic components, and more particularly, to a non-halogen flame-resistant resin composition that does not contain halogen.

B. Description of the Related Art

Since thermoplastic resins such as polyester and polyamide and thermosetting resins such as epoxy resin have superior moldability, mechanical strength and electrical properties for use as general-purpose resins and engineering plastics, they are widely used in various fields such as the fields of electricity and electronics. Resin molded articles obtained by processing and/or molding these resins are required to have flame resistance from the viewpoint of safety for the purpose of preventing fires caused by high temperatures, and standards such as UL94 have been established as flame resistance grades.

In general, halogen substances are known to be effective in making these resin molded articles flame resistant, and resin molded articles are made to be flame resistant by adding halogen flame retardants to these resins. The mechanism of flame resistance brought about by these halogen flame retardants is said to involve the formation of halogenated radicals mainly resulting from thermal decomposition, and as a result of the formed halogenated radicals capturing combustion sources in the form of organic radicals, the chain reaction of combustion is interrupted thereby resulting in the manifestation of high flame resistance.

However, flame retardants containing large amounts of halogen compounds have the potential to generate dioxins depending on the combustion conditions, and there has been a growing need to reduce halogen levels in recent years from the viewpoint of reducing the burden on the environment. Thus, studies are being conducted on various types of non-halogen flame retardants that do not contain halogen substances. For example, known examples of non-halogen flame retardants include organic phosphorous flame retardants such as phosphoric acid esters.

However, since organic phosphorous flame retardants are organic compounds, they are easily decomposed by heat during molding or kneading, and by the action of various types of components present in resin compositions, thereby resulting in increased susceptibility to exacerbation of moldability and kneadability. Since exacerbation of kneadability in particular prevents flame retardants, additives and the like from being uniformly dispersed in the resin, in addition to these resins being unable to demonstrate adequate flame resistance, they were also susceptible to inferior heat resistance.

In addition, non-halogen flame retardants are required to be incorporated in resins in larger amounts than ordinary halogen flame retardants. Consequently, the kneadability of the resin composition becomes poor and moldability is easily decreased. In addition, it also became difficult to uniformly disperse flame retardants, additives and the like in the resin, resulting in increased susceptibility to variations in various physical properties of the resulting molded articles, such as mechanical strength, electrical properties, flame resistance and the like. In the case of using thermoplastic resins in particular, heat resistance decreased easily in comparison with that of thermosetting resins.

On the other hand, in order to improve the heat resistance of the resulting resin molded articles, improvement of heat resistance has been disclosed in the following Japanese Patent Application Laid-open No. H10-212407 and Japanese Patent Application Laid-open No. 2004-203948 by adding an isocyanurate compound having a glycidyl group in the molecular structure thereof to resins.

However, even in the case of adding an isocyanurate compound having a glycidyl group in the molecular structure thereof to a resin as disclosed in the above-mentioned Japanese Patent Application Laid-open No. H10-212407 and Japanese Patent Application Laid-open No. 2004-203948, the kneadability and moldability of the resulting resin composition containing a flame retardant are inadequate, thus preventing the flame resistance and heat resistance of the resulting resin molded articles from being considered to be adequate.

The present invention is directed to overcoming or at least reducing the effects of one or more of the problems set forth above.

### SUMMARY OF THE INVENTION

Thus, it is desired to provide a flame-resistant resin composition that uses a non-halogen flame retardant as a flame retardant, and allows the obtaining of resin processed articles having superior flame resistance and heat resistance.

The flame-resistant resin composition of the present invention comprises: a non-halogen flame retardant (A) containing a metal phosphinate (a) represented by the following formula (I) and an organic phosphorous flame retardant (b), an isocyanurate compound (B) having one or more glycidyl groups in the molecular structure thereof, and a thermoplastic resin (C):

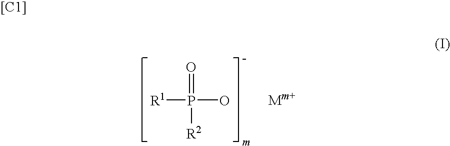

(wherein, R¹ and R² respectively represent an alkyl group having 1 to 6 carbon atoms or an aryl group having 12 carbon atoms or less, M represents calcium, aluminum or zinc, m=3 when M is aluminum, and m=2 when M is other than aluminum).

The above-mentioned metal phosphinate (a) vaporizes at a temperature of about 300 to 400° C. and easily decomposes to phosphine oxide ions and metal ions. Consequently, in resin processed articles obtained by molding a resin composition containing this compound, phosphine oxide ions migrate to the surface of the resin processed article during combustion. In addition, tin components are formed and deposited on the surface of resin processed articles accompanying resin decomposition during combustion and the like, and this results in the formation of char (thermal decomposition residue), which is strengthened by incorporation of metal ions and has high blocking effects with respect to heat and oxygen. Moreover, phosphorous compounds precipitate on the surface layer of this char. Consequently, in resin processed articles obtained using this metal phosphinate (a) in the resin composition, a diffusion layer having high flame resistance effects (flame-resistant layer) is formed by the phosphate compounds, thereby allowing superior flame resistance to be obtained.

The combined use of the metal phosphinate (a) and the organic phosphorous flame retardant (b) produces a synergistic effect, making it possible to demonstrate high flame resistance even when used in small amounts.

As a result of containing the isocyanurate compound (B), heat resistance of the resulting resin processed article can be improved.

Since combining the use of the metal phosphinate (a), the organic phosphorous flame retardant (b) and the isocyanurate compound (B) reduces the amount of gas generated when kneading the resin composition, kneadability improves and the flame retardant can be more uniformly dispersed in the resin. Consequently, the resulting resin molded article is free of variations in physical properties such as mechanical properties, electrical properties and flame resistance, while also having a satisfactory appearance. In addition, since the processing temperature during molding can be lowered, vaporization of flame retardant can be prevented thereby enabling the flame retardant to demonstrate superior flame resistance effects.

In the flame-resistant resin composition of the present invention, the organic phosphorous flame retardant (b) is preferably a reactive organic phosphorous flame retardant having an unsaturated group on the terminal thereof. Since reactive organic phosphorous flame retardants bond with resins as a result of being irradiated with heat or radiation, causing the resin to crosslink to a three-dimensional network structure, resin processed articles can be obtained having superior chemical stability, heat resistance, mechanical properties, electrical properties, dimensional stability, flame resistance and moldability, and heat resistance and mechanical strength in particular can be improved. Moreover, these organic phosphorous flame retardants also enable thin-walled molding. Since the flame retardant component is stable within the resin, there is less susceptibility to the flame retardant bleeding out from the resin, and superior flame resistance can be imparted for a long period of time with only a small amount of flame retardant.

In the flame-resistant resin composition of the present invention, the total content of the metal phosphinate (a) and the organic phosphorous flame retardant (b) is preferably 5 to 30% by weight.

In the flame-resistant resin composition of the present invention, the isocyanurate compound (B) is preferably a compound having one or more glycidyl groups and one or more allyl groups and/or methallyl groups within the molecular structure thereof. According to this aspect of the present invention, since allyl groups and/or methallyl groups within the isocyanurate compound (B) bond with resin as a result of being irradiated with heat or radiation, causing the resin to crosslink to a three-dimensional network structure, resin processed articles can be obtained having superior chemical stability, heat resistance, mechanical properties, electrical properties, dimensional stability, flame resistance and moldability, and heat resistance and mechanical strength in particular can be improved. In the flame-resistant resin composition of the present invention, the isocyanurate compound (B) is preferably present in amount of from 0.5 to 10% by weight.

The thermoplastic resin (C) is preferably a polyamide resin having a number average molecular weight of 10,000 to 30,000. According to this aspect of the present invention, the heat resistance and flame resistance of the resulting resin molded article can be further improved.

Since the flame-resistant resin composition of the present invention has superior kneadability and moldability enabling a flame retardant to be uniformly dispersed in a resin, resin processed articles can be obtained having superior physical properties such as mechanical properties, electrical properties, flame resistance and heat resistance, as well as a satisfactory appearance.

### DETAILED DESCRIPTION OF SPECIFIC EMBODIMENTS

The flame-resistant resin composition of the present invention is a resin composition comprising: a non-halogen flame retardant (A) containing a metal phosphinate (a) represented by the following general formula (I) and an organic phosphorous flame retardant (b), an isocyanurate compound (B) having one or more glycidyl groups in the molecular structure thereof, and a thermoplastic resin (C):

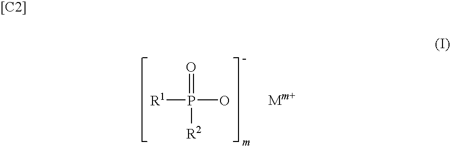

(wherein, R¹ and R² respectively represent an alkyl group having 1 to 6 carbon atoms or an aryl group having 12 carbon atoms or less, M represents calcium, aluminum or zinc, m=3 when M is aluminum, and m=2 when M is other than aluminum).

Since the above-mentioned metal phosphinate (a) used in the flame-resistant resin composition of the present invention vaporizes at a temperature of about 300 to 400° C. and easily decomposes to phosphine oxide ions and metal ions, it easily decomposes to phosphine oxide ions and metal ions during combustion, and the phosphine oxide ions easily migrate to the surface. Consequently, in resin processed articles obtained by molding a resin composition the metal phosphinate (a), phosphine oxide ions selectively precipitate on the surface layer resulting in the formation of char (thermal decomposition residue) having a diffusion layer (flame-resistant layer) comprised of a phosphorous compound and having an extremely large heat and oxygen blocking action. In addition, since metal ions generated by decomposition during combustion are able to make this char stronger, high flame resistance is obtained.

Since the metal phosphinate (a) has the risk making stacking difficult in the resin resulting in increased susceptibility to bleed-out if the molecular weight thereof is excessively large, R¹ and/or R² in the above-mentioned formula (I) is preferably a group selected from the group consisting of methyl, ethyl, n-propyl, isopropyl, n-butyl, tert-butyl, n-pentyl, phenyl and benzyl groups, and more preferably methyl and ethyl groups.

Specific examples of the metal phosphinate (a) include the compounds of (I-1) to (I-30) indicated below.

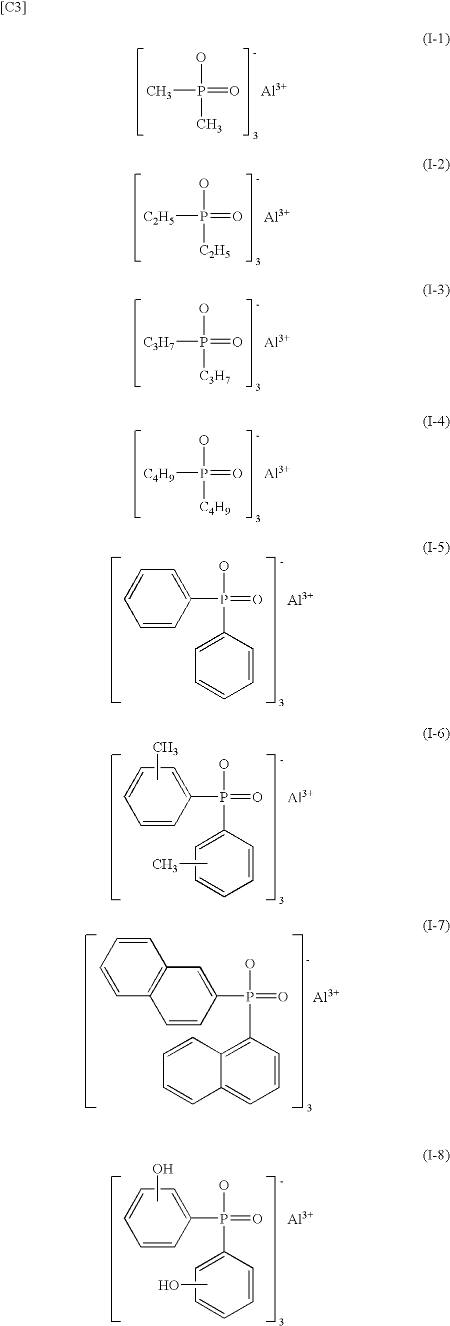

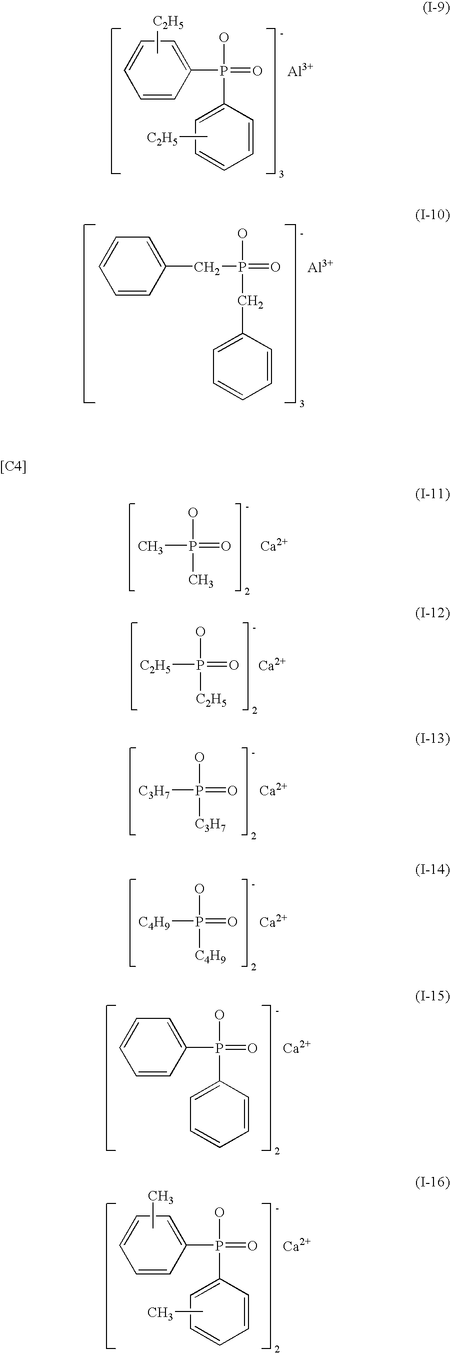

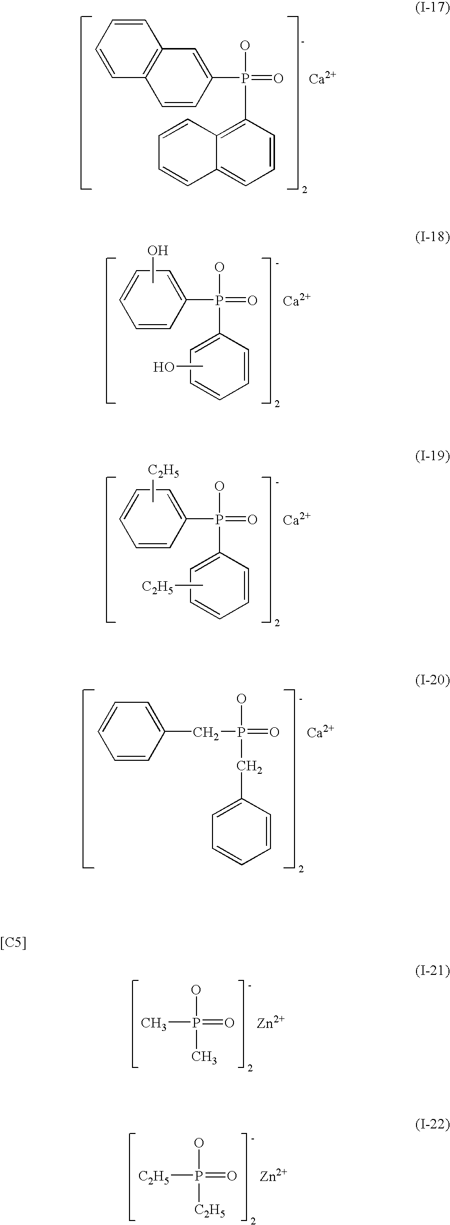

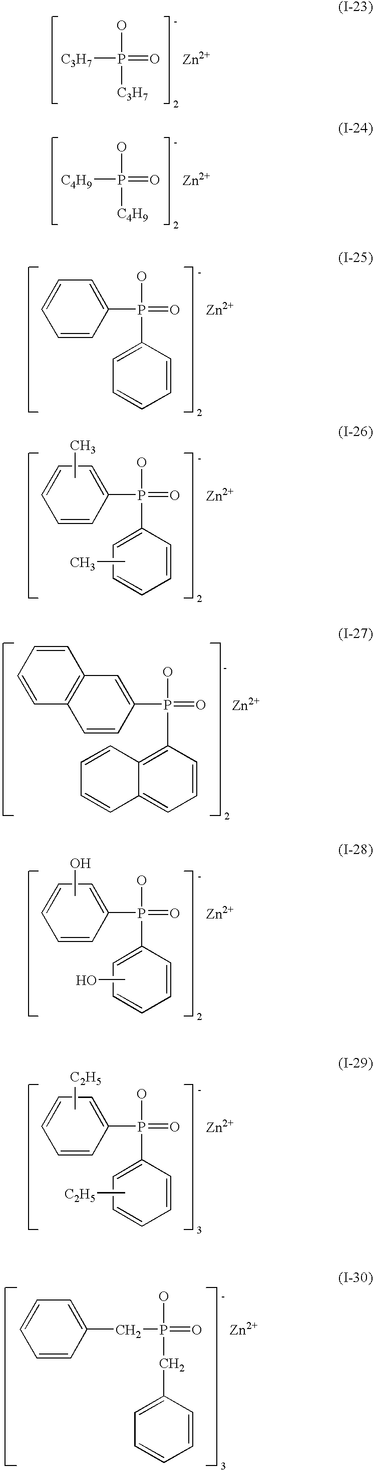

The metal phosphinate (a) is preferably contained in the flame-resistant resin composition of the present invention at 5% by weight or more, and more preferably at 5 to 20% by weight. If the content of the metal phosphinate (a) is less than 5% by weight, flame resistance is unable to be adequately obtained.

Furthermore, a commercially available product may be used for this type of metal phosphinate, and examples of products that can be used include “OP-1230” (trade name, Clariant Corp.).

There are no particular limitations on the organic phosphorous flame retardant (b) able to be used in the flame-resistant resin composition of the present invention, and examples include 1) monophosphoric acid esters such as such as triphenyl phosphate or tricresyl phosphate, 2) phosphoric acid esters such as bisphenol A bis(diphenyl)phosphate or resorcinol bis(diphenyl)phosphate, 3) phosphates such as ammonium polyphosphate, amide polyphosphate, guanidine phosphate or melamine polyphosphate, and 4) reactive organic phosphorous flame retardants having an unsaturated group on the terminal thereof. These organic phosphorous flame retardants may be used alone, or two or more types may be used in combination.

In the present invention, the organic phosphorous flame retardant (b) is preferably a reactive organic phosphorous flame retardant having an unsaturated group on the terminal thereof, and particularly preferably an organic phosphorous flame retardant at least having a terminal allyl group within the molecular structure thereof. Since reactive organic phosphorous flame retardants having an unsaturated group on the terminal thereof bond with resin as a result of being subjected to heat or radiation, causing the resin to crosslink to a three-dimensional network structure, mechanical properties, thermal properties and electrical properties can be improved when used in the form of a resin processed article. Since the flame retardant bonds with resin and is stable within the resin, there is less susceptibility of the flame retardant bleeding out from the resin. As a result of using in combination with the above-mentioned metal phosphinate (a), high flame resistance can be imparted due to a synergistic effect even if only a small amount of flame retardant is added.

Examples of the reactive organic phosphorous flame retardant compounds of (II-1) to (II-22) indicated below. Compounds having three or more allyl groups and one or more aromatic hydrocarbon groups having 20 carbon atoms or less within the molecular structure thereof are particularly preferable.

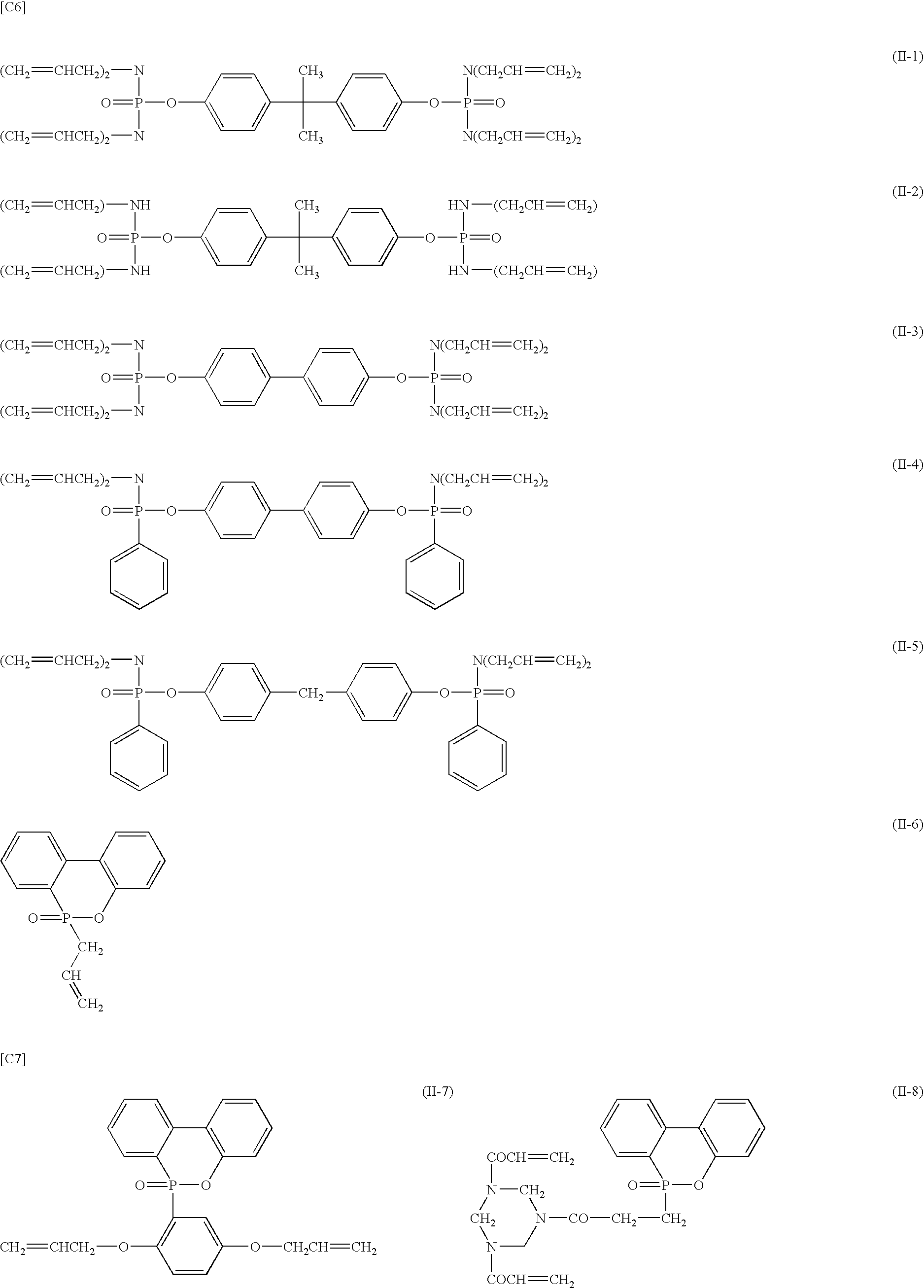

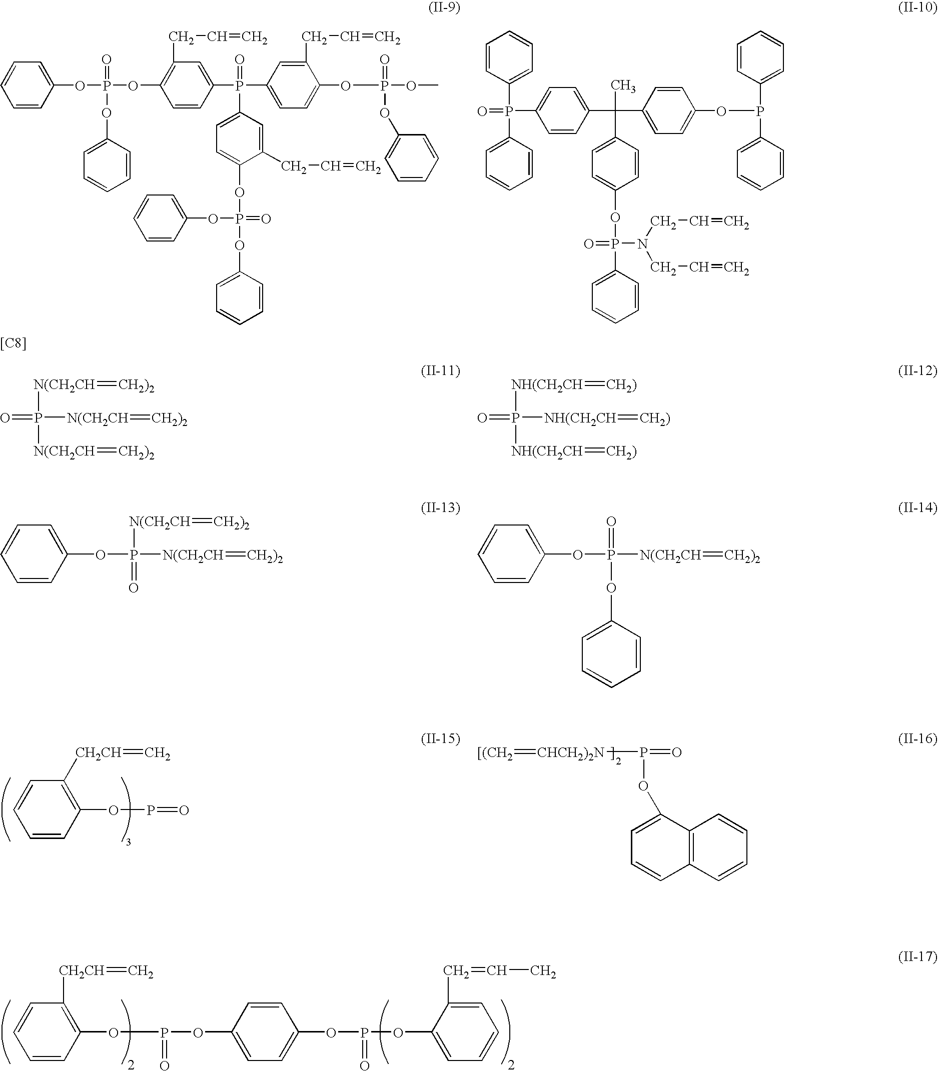

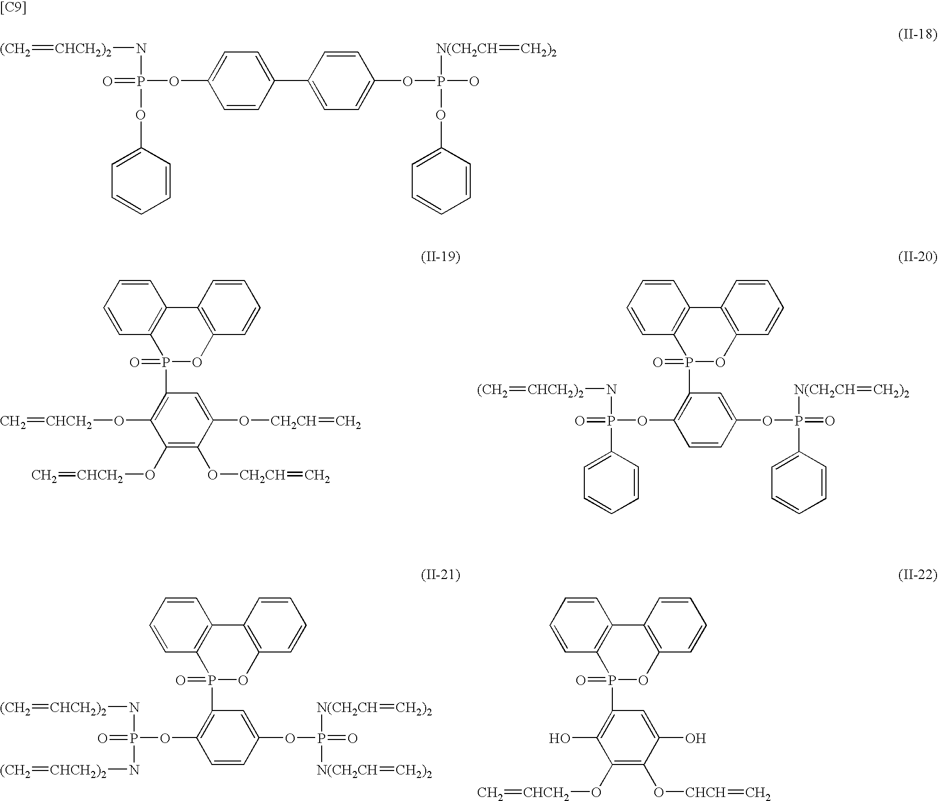

The above-mentioned compounds can be obtained by, in the case of the compound (II-1), for example, adding phosphorous oxychloride to dimethylacetoamide (DMAc), dropping a DMAc solution in which is dissolved 2,2′-bis(4-hydroxyphenyl)propane and triethylamine into this solution and allowing to react, and reacting a mixture with diallylamine.

The compound of (II-9) can be obtained by adding dimethylformamide (DMF) to [tris(3-allyl-4-hydroxyphenyl) phosphine oxide], and then dropping into this solution a DMF solution in which is dissolved diphenyl phosphate chloride, and allowing the combination to react.

The compound of (II-10) can be obtained by dropping a DMF solution in which is dissolved diphenyl phosphate monochloride into a distilled chloroform solution in which is dissolved 1,1,1-tris(4-hydroxyphenyl)ethane and triethylamine, and then dropping in a DMF solution in which is dissolved phenyl phosphonate mono(N,N-diallyl)amide monochloride and allowing to react.

The compound (II-20) can be obtained by dropping, in dichlorophenylphosphine, a tetrahydrofuran solution in which is dissolved 10-(2,5-dihydroxyphenyl)-9-oxo-10-phospho-9,10-dihydroxyphenanthren-10-one and triethyl-amine and allowing to react.

Furthermore, the other compounds can be synthesized based on methods similar to those described above or on methods described in, for example, Japanese Patent Application Laid-open No. 2004-315672.

The organic phosphorous flame retardant (b) is preferably contained in the flame-resistant resin composition of the present invention in an amount of 1 to 20% by weight, and more preferably an amount of 1 to 15% by weight.

The total content of the metal phosphinate (a) and the organic phosphorous flame retardant (b) in the flame-resistant resin composition is preferably 5 to 30% by weight, more preferably 10 to 22% by weight, and even more preferably 14 to 18% by weight. If the above-mentioned total content is less than 5% by weight, flame resistance of the resulting resin processed articles is not adequately obtained. If the total content exceeds 30% by weight, flame resistance becomes excessive and this results in the risk of the flame retardant component bleeding out, decomposition gas being generated by the flame retardant, or mechanical properties of resin processed articles decreasing.

The isocyanurate compound (B) containing a glycidyl group in the molecular structure thereof used in the flame-resistant resin composition of the present invention is preferably that which contains a glycidyl group, as well as an allyl group and/or methallyl group in the molecular structure thereof. As a result of the isocyanurate compound (B) being contained in the resin composition, the heat resistance of the resulting resin processed article can be improved. In the case where the isocyanurate compound (B) contains an allyl group and/or methallyl group, since the allyl group and/or methallyl group bonds with resin as a result of being irradiated with heat or radiation, causing the resin to crosslink to a three-dimensional network structure, a resin processed article can be obtained which has superior chemical stability, heat resistance, mechanical properties, electrical properties, dimensional stability, flame resistance and moldability. Flame resistance and mechanical strength in particular can be improved. Although the reason is not clear, since combined use of the metal phosphinate (a), the organic phosphorous flame retardant (b) and the isocyanurate compound (B) reduces the amount of gas generated during kneading of the resin composition, kneadability improves and flame retardant can be more uniformly dispersed in the resin. Consequently, resulting molded articles are free of variations in various properties such as mechanical properties, electrical properties, flame resistance or heat resistance, while also having a satisfactory appearance. Since the processing temperature during molding is lowered, vaporization of the flame retardant can be prevented thereby enabling the flame retardant to demonstrate superior flame resistance effects.

Specific examples of the above-mentioned isocyanurate compound (B) include monoglycidyl isocyanurate, diglycidyl isocyanurate, triglycidyl isocyanurate, monoallyl diglycidyl isocyanurate and diallyl monoglycidyl isocyanurate, with monoallyl diglycidyl isocyanurate and diallyl monoglycidyl isocyanurate being preferable.

A commercially available product may be used for the isocyanurate compound (B) having a glycidyl group in the molecular structure thereof, an example of a product that can be used is “DA-MGIC” (trade name, Shikoku Chemicals Corp.).

There are no particular limitations on the thermoplastic resin (C) used in the flame-resistant resin composition of the present invention, and examples include polyester resins such as polyamide resins, polybutylene terephthalate resins or polyethylene terephthalate resins, polystyrene resins such as polyacrylic resins, polyimide resins, polycarbonate resins, polyurethane resins, polystyrene, acrylonitrile-styrene copolymers or acrylonitrile-butadiene-styrene copolymers, and polyacetal resins, polyolefin resins, polyphenylene oxide resins, polyphenylene sulfide resins and polybutadiene resins. In particular, polyamide resins, polybutylene terephthalate resins, polyethylene terephthalate resins, polycarbonate resins, polyacrylic resins, polyacetal resins and polyphenylene oxide resins are preferable from the viewpoint of mechanical properties and heat resistance, and polyamide resins having a number average molecular weight of 10,000 to 30,000 are particularly preferable. The use of a polyamide resin having a number average molecular weight of 10,000 to 30,000 results in satisfactory mechanical properties and heat resistance of the resulting resin processed article.

The flame-resistant resin composition of the present invention may further contain a filler in addition to the non-halogen flame retardant (A), the isocyanurate compound (B) having one or more glycidyl groups in the molecular structure thereof, and the thermoplastic resin (C). As a result of containing a filler, the mechanical strength, heat resistance and dimensional stability of resulting resin processed articles can be improved.

In the present invention, there are no particular limitations on the material of the filler, and specific examples thereof include silica gel, alumina, carbon black, copper, iron, nickel, zinc, tin, stainless steel, aluminum, gold, silver and other metal powders, fumed silica, aluminum silicate, calcium silicate, silicic acid, hydrated calcium silicate, hydrated aluminum silicate, glass beads, quartz powder, mica, talc, clay, titanium oxide, iron oxide, zinc oxide, calcium carbonate, magnesium carbonate, magnesium oxide, calcium oxide, magnesium sulfate, potassium titanate and diatomaceous earth.

In the case of containing a filler, the content of the filler in the flame-resistant resin composition is preferably 1 to 40% by weight and more preferably 1 to 25% by weight. If the content is less than 1% by weight, reinforcing effects of the filler are hardly obtained at all, while if the content exceeds 40% by weight, the resulting resin processed article tends to become brittle.

The flame-resistant resin composition of the present invention may further contain reinforcing fiber. As a result of containing reinforcing fiber, in addition to the mechanical strength of resulting molded articles being improved, dimensional stability can also be improved.

Examples of reinforcing fibers include glass fiber, carbon fiber and metal fiber, and glass fiber is used preferably from the viewpoint of strength and adhesion between the fiber and inorganic filler. These reinforcing fibers may be used alone or two or more types may be used in combination. The reinforcing fibers may also be treated with a known surface treatment agent such as a silane coupling agent. The glass fiber is preferably one which has been surface treated and further coated with resin. This makes it possible to further improve adhesion with thermoplastic polymers.

A known silane coupling agent can be used as the surface treatment agent for surface treatment of glass fibers, and specific examples thereof include silane coupling agents having at least one type of alkoxy group selected from the group consisting of methoxy and ethoxy groups, and at least one type of reactive functional group selected from the group consisting of an amino group, vinyl group, acrylic group, methacrylic group, epoxy group, mercapto group, halogen atom and isocyanate group.

There are no particular limitations on the resin used to coat the glass fibers, and examples thereof include urethane resin and epoxy resin.

In the case of containing reinforcing fiber, the content of reinforcing fiber in the flame-resistant resin composition is preferably 5 to 40% by weight and more preferably 10 to 35% by weight. If the content is less than 5% by weight, reinforcing effects of the reinforcing fiber are hardly obtained at all, while if the content exceeds 40% by weight, molding into resin processed articles tends to be difficult.

In the flame-resistant resin composition of the present invention, in the case of respectively containing a filler and reinforcing fiber, the total content of the filler and reinforcing fiber is preferably 65% by weight or less and more preferably 55% by weight or less. If the total content of the filler and reinforcing fiber exceeds 65% by weight, moldability decreases due to a reduction in the proportion of the resin component, or resulting resin processed articles become brittle resulting in a decrease in physical properties, thereby making this undesirable.

Various types of routinely used components in addition to those described above, including additives such as a crystal nucleator, colorant, antioxidant, mold release agent, plasticizer, heat stabilizer, lubricant, crosslinking agent or ultraviolet preventer, can be added to the flame-resistant resin composition of the present invention within a range that does not remarkably impair the object of the present invention in the form of physical properties such as heat resistance, weather resistance or impact resistance.

Although there are no particular limitations on the colorant, that which is not discolored by irradiation with radiation to be described later is preferable, and examples of preferably used colorants include red iron oxide, black iron oxide, carbon black and chrome yellow, as well as metal complexes such as phthalocyanine.

The flame-resistant resin composition of the present invention can be used to obtain resin processed articles by forming the resin composition into pellets using a single screw or twin screw extruder, Banbury mixer, kneader, mixing roll or other ordinary melting and kneading processing machine, and then shaping into a prescribed shape by injection molding, extrusion molding, vacuum molding or inflation molding and the like. The kneading temperature can be suitably selected according to the type of thermoplastic resin, and in the case of polyamide resin, for example, kneading is preferably carried out at 240 to 280° C. Molding conditions can also be suitably set according to the resin, and there are no particular limitations thereon. Furthermore, since crosslinking has not yet progressed at this stage, excess spool during molding can be recycled as thermoplastic resin.

In the case of adding a compound having an unsaturated group on the terminal thereof in the flame-resistant resin composition of the present invention, irradiation with heat or radiation is preferably carried out after shaping to a prescribed shape in order to crosslink the compound with the resin. Since the unsaturated group reacts with the resin as a result of irradiating with heat or radiation, the heat resistance and the like of the resin is improved.

In the case of using heat as the means for reacting the resin with the compound having an unsaturated group on the terminal thereof, the temperature at which they are reacted is preferably a temperature at least 5° C. higher, and more preferably at least 10° C. higher, than the molding temperature of the resin.

In the case of using radiation as means for reacting the resin with the compound having an unsaturated group on the terminal thereof, an electron beam, α rays, γ rays, X-rays or ultraviolet rays and the like can be used. Furthermore, in the present invention, the term “radiation” is used in the broad sense of the word, and specifically includes particles beams such as an electron beam or αrays, as well as electromagnetic waves such as X-rays or ultraviolet rays.

Among the above forms of radiation, irradiation with an electron beam or γ rays is preferable. A known electron accelerator and the like can be used for irradiating an electron beam, and the acceleration energy is preferably 2.5 MeV or more. An irradiation device using a known cobalt 60 source and the like can be used for irradiation of γ rays.

An irradiation device using a known cobalt 60 source and the like can be used for irradiation of γ rays. Although irradiation of γ rays is preferable since the irradiation is uniform due to the stronger degree of penetration of γ rays as compared with an electron beam, due to the high intensity of the irradiation, it is necessary to control the dose to prevent excessive irradiation.

The irradiated dose of radiation is preferably 10 kGy or more and more preferably 10 to 45 kGy. If the dose is within this range, a resin processed article having superior physical properties as previously described can be obtained by crosslinking. If the irradiated dose is less than 10 kGy, the formation of the three-dimensional network structure by crosslinking becomes uneven and unreacted crosslinking agent may bleed out, thereby making this undesirable. In addition, if the dose exceeds 45 kGy, internal strain remains within the resin processed article caused by oxidative decomposition products, and this causes deformation, shrinkage and the like, thereby making this undesirable.

A resin processed article obtained in this manner has superior mechanical properties, electrical properties, dimensional stability and moldability in addition to superior heat resistance and flame resistance. Thus, such a resin processed article can be preferably used in electrical or electronic components requiring high levels of heat resistance and flame resistance, and in automotive components and optical components, including members for contact support of electromagnetic switches and circuit breakers, boards such as printed circuit boards, integrated circuit packages, and electrical component housings.

Specific examples of electrical or electronic components include power receiving panels, power distribution panels, electromagnetic switches, circuit breakers, transformers, electromagnetic contacts, circuit protectors, relays, transformers, various types of sensors, various types of motors, diodes, transistors, and integrated circuits and other semiconductor devices. These resin processed articles can also be preferably used as automotive components such as cooling fans, bumpers, brake covers, panels and other interior articles, as well as sliding parts, sensors and motors. In addition to being used in the form of molded articles, these resin processed articles can also be used as flame-resistant coated films for the above-mentioned molded articles, fibers and the like.

The use of these resin processed articles as packages, coatings or insulators of electrical or electronic components such as the above-mentioned semiconductor devices makes it possible to impart superior heat resistance and flame resistance. Namely, by packaging the above-mentioned resin composition, curing the resin, and then reacting by irradiating with heat or radiation as previously described, the resin composition can be used as a flame-resistant package for packaging electronic components or electrical elements such as semiconductor chips or ceramic condensers. Examples of packaging methods that can be used include injection molding, potting, transfer molding, injection molding and compression molding. Although there are no particular limitations on the electronic components or electrical components subject to packaging, examples include liquid crystal, integrated circuits, transistors, thyristors, diodes and condensers.

Although the following provides a more detailed explanation of the present invention using examples thereof, the present invention is not limited to these examples.

### Example 1

A flame-resistant resin composition was obtained by blending 49.5 parts by weight of the thermoplastic resin (C) in the form of Nylon 66 (Ube Industries, Ltd.: 2020B), 25 parts by weight of reinforcing fiber in the form of glass fiber having a fiber length of about 3 mm surface-treated with a silane coupling agent (Asahi Fiber Glass Co., Ltd.: 03.JAFT2Ak25), 0.2 parts by weight of colorant in the form of carbon black, 0.3 parts by weight of antioxidant (Ciba Specialty Chemicals, Inc.: Irganox 1010), 8 parts by weight of filler in the form of finely powdered synthetic silica (Fuji Silysia Chemical Ltd.: Sylysia 530), 12 parts by weight of metal phosphinate (a) represented by formula (I) (trade name: Exolit OP1230, Clariant Corp.), 3 parts by weight of organic phosphorous flame retardant (b) in the form of the compound represented by the above-mentioned formula (II-3), and 2 parts by weight of isocyanurate compound (B) containing a glycidyl group in the molecular structure thereof (trade name: DA-MGIC, Shikoku Chemicals Corp.). This flame-resistant resin composition was kneaded at 270° C. with a side flow twin-screw extruder (Japan Steel Works, Ltd.) to obtain resin pellets, and after drying for 4 hours at 115° C., the resin pellets were molded using an injection molding machine (Fanuc, Ltd.: α50C) under conditions of a resin temperature of 265° C. and mold temperature of 80° C. to obtain a resin processed article.

### Example 2

A flame-resistant resin composition was obtained by blending 51.5 parts by weight of the thermoplastic resin (C) in the form of Nylon 66 (Ube Industries, Ltd.: 2020B), 25 parts by weight of reinforcing fiber in the form of glass fiber having a fiber length of about 3 mm surface-treated with a silane coupling agent (Asahi Fiber Glass Co., Ltd.: 03.JAFT2Ak25), 0.2 parts by weight of colorant in the form of carbon black, 0.3 parts by weight of antioxidant (Ciba Specialty Chemicals, Inc.: Irganox 1010), 8 parts by weight of filler in the form of finely powdered synthetic silica (Fuji Silysia Chemical Ltd.: Sylysia 530), 10 parts by weight of metal phosphinate (a) represented by formula (I) (trade name: Exolit OP1230, Clariant Corp.), 3 parts by weight of organic phosphorous flame retardant (b) in the form of the compound represented by the above-mentioned formula (II-3), and 2 parts by weight of isocyanurate compound (B) containing a glycidyl group in the molecular structure thereof (trade name: DA-MGIC, Shikoku Chemicals Corp.). This flame-resistant resin composition was kneaded at 270° C. with a side flow twin-screw extruder (Japan Steel Works, Ltd.) to obtain resin pellets, and after drying for 4 hours at 115° C., the resin pellets were molded using an injection molding machine (Fanuc, Ltd.: α50C) under conditions of a resin temperature of 265° C. and mold temperature of 80° C. to obtain a resin processed article.

### Comparative Example 1

A flame-resistant resin composition was obtained in the same manner as Example 1 with the exception of blending 2 parts by weight of an isocyanurate compound not containing a glycidyl group in the form of TAIC (Tokyo Chemical Industry Co., Ltd.) instead of the isocyanurate compound (B) containing a glycidyl group in the molecular structure thereof used in Example 1. This flame-resistant resin composition was kneaded at 280° C. with a side flow twin-screw extruder (Japan Steel Works, Ltd.) to obtain resin pellets, and after drying for 4 hours at 115° C., the resin pellets were molded using an injection molding machine (Fanuc, Ltd.: α50C) under conditions of a resin temperature of 270° C. and mold temperature of 80° C. to obtain a resin processed article.

### Comparative Example 2

A flame-resistant resin composition was obtained in the same manner as Example 1 with the exception of blending 2 parts by weight of an isocyanurate compound not containing a glycidyl group in the form of TAIC (Tokyo Chemical Industry Co., Ltd.) instead of the isocyanurate compound (B) containing a glycidyl group in the molecular structure thereof used in Example 2. This flame-resistant resin composition was kneaded at 280° C. with a side flow twin-screw extruder (Japan Steel Works, Ltd.) to obtain resin pellets, and after drying for 4 hours at 115° C., the resin pellets were molded using an injection molding machine (Fanuc, Ltd.: α50C) under conditions of a resin temperature of 270° C. and mold temperature of 80° C. to obtain a resin processed article.

### Test Examples

Test pieces complying with a test of flammability in the form of UL-94 (5 inches long, ½ inch wide, 3.2 mm thick), glow wire test pieces complying with IEC60695 Method 2 (GWFI) (60 mm on a side, 3.2 mm thick), and Izod impact test pieces (80 mm long, 4 mm wide, 10 mm thick) were fabricated for the resin processed articles of Examples 1 and 2 and Comparative Examples 1 and 2, and a test in accordance with UL94, a glow wire test (in compliance with IEC), an Izod impact test (in compliance with JIS), and a storage test in a high-temperature, high-humidity environment (45° C., 90%, 100 hours) were carried out. The results are summarized in Table 1.

Furthermore, in the test carried out in accordance with UL94, the test piece was attached vertically, and combustion time was recorded after contacting with a flame for 10 seconds with a Bunsen burner. Moreover, combustion time was again recorded after contacting with a flame for 10 seconds a second time after extinguishing. The flame resistance was evaluated based on the total combustion time, glowing combustion time after the second extinguishing, and the presence or absence of falling debris that ignited cotton. This procedure was carried out on five test pieces. The glow wire test was carried out by using a nichrome wire having a diameter of 4 mm bent so that the end thereof is not split for the glow wire (components: 80% nickel, 20% chrome), using a type K thermocouple (chromel-alumel) having a diameter of 0.5 mm for the thermocouple used to measure temperature, and carrying out testing at a thermocouple clamping load of 1.0±0.2 N and temperature of 850° C. Furthermore, flame resistance (GWFI) was evaluated based on criteria consisting of the combustion time after contact for 30 seconds being within 30 seconds, and the tissue paper beneath the sample not igniting. The Izod impact test was carried out in compliance with JIS K 7110, testing was carried out on five test pieces each using a notch depth of 2 mm, and the test results were expressed as the mean values thereof. Molded appearance was evaluated visually.

TABLE 1

| | Flame resistance test (UL-94) | | | | | | | | |
|---|---|---|---|---|---|---|---|---|---|
| | | | | | | Ignition of | | | |
| | | Total | Min. | Max. | | absorbent | | Izod | |
| | | combustion | combustion | combustion | Sparks | cotton by | | impact | |
| | | time | time | time | reaching | falling | Glow | test | |
| | Evaluation | (sec) | (sec) | (sec) | clamp | debris | wire test | (kJ/m²) | Appearance |
| Ex. 1 | V-0 | 30 | 1 | 4 | None | None | Passed | 5.73 | Luster |
| Ex. 2 | V-0 | 48 | 0 | 8 | None | None | Passed | 6.16 | Luster |
| Comp. | V-0 | 48 | 0 | 10 | None | None | Passed | 5.10 | Little |
| Ex. 1 | | | | | | | | | luster |
| Comp. | V-1 | 87 | 7 | 19 | None | None | Passed | 5.34 | Little |
| Ex. 2 | | | | | | | | | luster |

According to the results of Table 1, the resin processed articles of Examples 1 and 2 were determine to have superior flame resistance evaluated as V-0, and all samples passed the glow wire test as well.

On the other hand, in the resin processed articles of Comparative Examples 1 and 2, to which an isocyanurate compound (B) containing a glycidyl group in the molecular structure thereof was not added, although flammability was evaluated as V-0 or V-1, there were large variations in combustion time. In addition, Izod impact values also decreased. Moreover, the appearances of the molded articles exhibited little luster. The flame-resistant resin compositions of Comparative Examples 1 and 2 exhibited poor kneadability, and the resin temperature during molding was 5 to 10° C. higher than the flame-resistant resin compositions of Examples 1 and 2.

The present invention can be preferably used in resin molded articles such as electrical components and electronic components.

Thus, a flame-resistant resin composition has been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

This application is based on and claims priority to Japanese Patent Application JP 2008-249710, filed on Sep. 29, 2008. The disclosure of the priority application in its entirety, including the drawings, claims, and the specification thereof, is incorporated herein by reference.

What is claimed is:

1. A flame-resistant resin composition, comprising:
a non-halogen flame retardant (A) containing
a metal phosphinate (a) represented by the following formula (I) 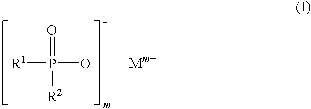
wherein, R¹ and R² respectively represent an alkyl group having 1 to 6 carbon atoms or an aryl group having 12 carbon atoms or less, M represents calcium, aluminum or zinc, m=3 when M is aluminum, and m=2 when M is other than aluminum, and
an organic phosphorous flame retardant (b);
an isocyanurate compound (B) having one or more glycidyl groups in the molecular structure thereof; and
a thermoplastic resin (C).

2. The flame-resistant resin composition according to claim 1, wherein the organic phosphorous flame retardant (b) is a reactive organic phosphorous flame retardant having an unsaturated group on the terminal thereof.

3. The flame-resistant resin composition according to claim 1, wherein the total content of the metal phosphinate (a) and the organic phosphorous flame retardant (b) is 5 to 30% by weight.

4. The flame-resistant resin composition according to claim 1, wherein the isocyanurate compound (B) is a compound having one or more glycidyl groups and one or more allyl groups, one or more methallyl groups, or a combination of allyl and methallyl groups in the molecular structure thereof.

5. The flame-resistant resin composition according to claim 1, wherein the isocyanurate compound (B) is contained at 0.5 to 10% by weight.

6. The flame-resistant resin composition according to claim 1, wherein the thermoplastic resin (C) is a polyamide resin having a number average molecular weight of 10,000 to 30,000.

7. The flame-resistant resin composition according to claim 2, wherein the isocyanurate compound (B) is a compound having one or more glycidyl groups and one or more allyl groups, one or more methallyl groups, or a combination of allyl and methallyl groups in the molecular structure thereof.

8. The flame-resistant resin composition according to claim 7, wherein the thermoplastic resin (C) is a polyamide resin having a number average molecular weight of 10,000 to 30,000.

9. The flame-resistant resin composition according to claim 8, wherein the total content of the metal phosphinate (a) and the organic phosphorous flame retardant (b) is 5 to 30% by weight.

10. The flame-resistant resin composition according to claim 9, wherein the isocyanurate compound (B) is contained at 0.5 to 10% by weight.

11. The flame-resistant resin composition according to claim 7, wherein the isocyanurate compound (B) is contained at 0.5 to 10% by weight.

12. The flame-resistant resin composition according to claim 2, wherein the total content of the metal phosphinate (a) and the organic phosphorous flame retardant (b) is 5 to 30% by weight.

13. The flame-resistant resin composition according to claim 4, wherein the isocyanurate compound (B) is contained at 0.5 to 10% by weight.
